(19) United States
(12) Patent Application Publication
(10) Pub. No.: US 2008/0270661 A1
(43) Pub. Date: Oct. 30, 2008

(54) Interruption Management

(76) Inventor: Kevin I. Plumpton, Auckland (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/033,195

(22) Filed: Feb. 19, 2008

(30) Foreign Application Priority Data
Feb. 19, 2007 (NZ) 553309

(51) Int. Cl. G06F 13/24

(52) U.S. Cl. 710/262; 710/260

(57) ABSTRACT

The present invention relates to a method, system 1 and/or software 16 for handling interruptions. Upon interruption, a user can place an indicator 60 on their screen. The applications are removed from view. Upon ending the interruption, the applications are redisplayed with a recall indicator 130. During the interruption, information relating to common tasks can be displayed 81.

### FIELD OF THE INVENTION

The present invention relates to a system, software and/or method for managing interruptions while undertaking tasks with the use of a computer.

### BACKGROUND TO THE INVENTION

Due to the fast pace of work these days, along with the large number of means by which people can communicate, interruptions are common place. In a typical office or other work environment, interruptions take place constantly throughout a worker's day. For example, while carrying out work tasks at a workstation, which might include using the computer, a worker is frequently interrupted by work colleagues, clients and other people in a number of ways. For example, they can be physically interrupted by the person approaching them, or they can be interrupted by a communications means such as email, instant messaging, telephone or the like.

It is well documented that interruptions are very disruptive to the productivity of workers. Even after the actual interruption has finished, it can take many minutes for the interrupted person to return to their original task, regain their thought train and carry on productively in completing that task. Even very short interruptions can be very disruptive to productivity.

### SUMMARY OF INVENTION

Is it an object of the present invention to assist a user to handle interruptions.

In one aspect the present invention may be said to consist in a method for alleviating the effects of an interruption on a user using computer applications displayed on a screen, the method comprising the steps of: receiving input for positioning a marker indicator at a position on the screen and/or for indicating an interruption has occurred, removing the marker indicator and one or more of the computer applications from view, and upon receiving input indicating termination of the interruption, redisplaying the one or more computer applications and displaying a recall indicator on the screen in a position corresponding to the marker indicator.

Preferably the method comprises the step of reporting an interruption start time to a computer system.

Preferably the method comprises the step of reporting an interruption stop time to a computer system.

Preferably the method comprises prior to removing the computer applications from view, at least partially obscuring at least some portion of the screen.

Preferably the input for positioning the marker indicator is received from mouse or keyboard input.

In another aspect the present invention comprises a method for improving the efficiency of interruptions for an interruptee, the method comprising the steps of: receiving input indicating an interruption, receiving input identifying the interrupter, displaying information pertaining to the interrupter.

Preferably the information pertaining to the interrupter comprises activities that have been defined by the interruptee and have been defined as being associated with the interrupter, the method further comprising the step of determining activities defined by the interruptee that are associated with the interrupter.

Preferably the information pertaining to the interrupter comprises activities that have been defined by the interrupter and have been defined as being associated with the interruptee, the method further comprising the step of determining activities defined by the interrupter that are associated with the interruptee.

Preferably the method comprises the step of reporting the interruption start time to a computer system.

Preferably the method comprises the step of reporting the interruption stop time to a computer system.

Preferably the method comprises the step of receiving input indicating the length of the interruption.

Preferably the method comprises the step of receiving input indicating the time at which the user is next available.

Preferably the method comprises the step of receiving input indicating the next scheduled meeting between the user and the interrupter.

Preferably the method comprises the step of receiving input indicating discussion topics recorded by the user for the interrupter.

Preferably the method comprises the step of receiving input indicating discussion topics recorded by the interrupter for the user.

Preferably the information pertaining to the interrupter comprises information relating to activities common to the user and interrupter.

Preferably the information pertaining to the interrupter is obtained from activities specified for the interrupter.

Preferably, the method comprises the step of receiving a rating for an interruption.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

The term “comprising” as used in this specification means “consisting at least in part of”. Related terms such as “comprise” and “comprised” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

Preferred embodiments of the invention will be described with reference to the following drawings of which:

FIG. 1 is a schematic diagram of a computer system that implements an interruption management method and software according to one embodiment of the invention,

FIG. 2 is a schematic diagram of a computer system according to another embodiment,

FIGS. 3a, 3b are flow diagrams showing a method of managing interruptions according to one embodiment of the invention from an interruptee's and a computer system perspective respectively,

FIGS. 4a, 4b are flow diagrams showing a method of managing interruptions according to another embodiment of the invention from an interruptee's and a computer system perspective respectively.

FIG. 5 is a screen shot of a control for indicating an interruption has taken place,

FIG. 6 is a screen shot of a computer screen after interruption has been triggered, including a market indicator,

FIG. 7 is a screen shot of a computer screen after computer applications have been removed from a screen,

FIGS. 8, 9 and 10 are screen shot of a recall screen showing activities common to the interrupter and interruptee,

FIGS. 11 and 12 are screen shots showing rating of an interruptions,

FIG. 13 shows a screen with applications re-displayed after interruption, along with a recall indicator,

FIGS. 14 to 18 are screen shots of the project definition process.

### DETAILED DESCRIPTION OF PREFERRED EMBODIMENTS

The present invention relates to a method, system and software for alleviating the disruption due to interruptions. The invention will typically relate to a worker or similar using a computer to carry out at least some of their daily tasks. Typically, this will be a worker in an office or other similar environment, or a worker that works remotely but that can be interrupted by various means from other workers or related people.

In general terms the invention enables a worker to optimise their productivity despite interruptions. In one embodiment, the invention enables a worker to minimise the negative effects of an interruption by stabilising their memory on the task that they were dealing with prior to the interruption, and having an reminder of their task when they return to it after the interruption has ended. In addition or alternatively, in one embodiment the invention can also relate to the provision of information relating to the interrupter, so that common task, meetings or other activities relating to the interrupter can be recalled by the interruptee and discussed at the time of the interruption.

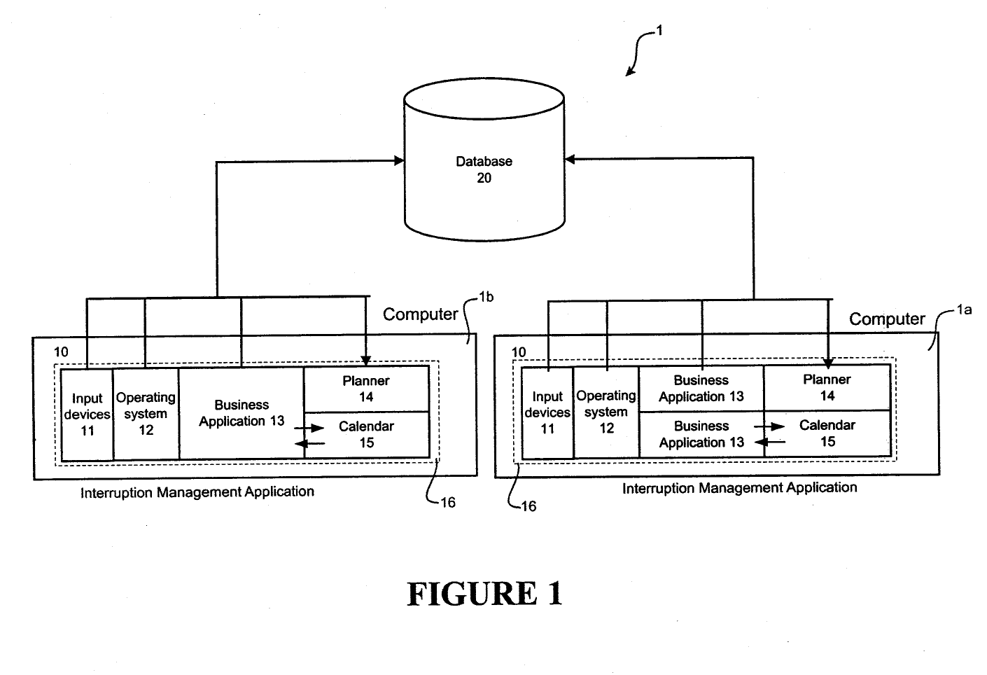

FIG. 1 shows an overview of a typical computer system 1 that might implement the method and software of the present invention. The system comprises two computer systems 1a, 1b that are used by two workers on the system. The computers are networked and also share a database 20. It will be appreciated that, in practice, such a system 1 is likely to contain a large number of networked computers, each one being used by a worker in the organisation. Only two computers are shown in FIG. 1 for simplicity. With respect to the present description, computer 1a will relate to the interruptee's computer (that is the person being interrupted) and computer 1b will relate to the interrupter's (that is the person doing the interruption) computer. It will be appreciated that in practice a computer user can be an interrupter and an interruptee on different occasions, depending on the circumstances. Further, the computer can operate in respect of both roles that the worker might take.

Each end user computer terminal comprises a personal computer 1a, 1b that utilises one or more input devices 11, and operating system 12, and one or more business applications 13. The business applications might be, for example, word processing applications, spreadsheet applications, email client applications and web browsers. This is just an example and there are a large number of such applications that may be used to perform tasks on the computer by the user, and any number of such applications maybe installed on any end-user computer terminal. Only one business application is shown in computer 1b and two applications are shown in computer 1a for clarity. In general, most end user computer terminals 1a, 1b will generally have more than two such applications installed.

Each of the end user computer terminals 1a, 1b is also configured with the planner application 14 that enables the computer operator to record the times, dates and durations of tasks, and a calendar to record appointments. Tasks, projects, and goals that are recorded by the planner, and calendar items that are recorded in the calendar can generally be termed “activities”. A particular application, task, project, goal, calendar item or any other matter that a user may be working on at a certain time can be considered a current activity.

The terminals 1a, 1b also have interruption manager applications 16 that assist the user to manage interruptions. This application operates in conjunctions with the other software (described above) on the computer.

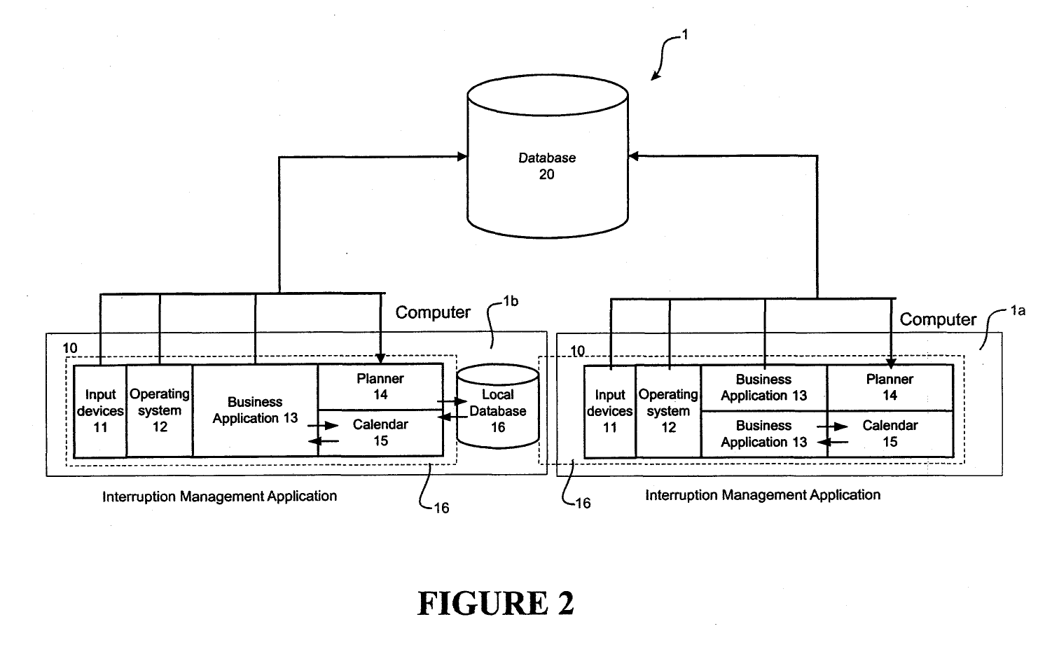

FIG. 2 illustrates an alternative embodiment of the computer system shown in FIG. 1. The computers, database and network are configured in the same manner, but in additional one of the computer terminals includes a local database 16, which cumulatively stores the data generated by the business applications over time. This configuration is useful for remote workers or mobile workers who are not connected to the work based LAN, continuously allowing for instant transfer of information to the database 20. Information can be transferred to the database 20 when the user connects to the work based LAN network. This allows for all information to be kept in a singular database 20 so all discussion based topics can be displayed to a user when they prompt for the information. Without such a database, the interruptee would only be presented with discussion topics that they initiated and would not be able to view the ones that the interrupter initiated.

The database 20 is also useful for management to keep track of any staff issues. By regularly activating a discussion topics screen and viewing what each of their staff have listed to discuss with them, they are able to keep abreast of any possible issues and ensure that their staff are catered for.

The computer system 1 operates software to provide the interruption management. This software may reside on one or more of the computers and/or on a network server. The software is distributed across machines as necessary.

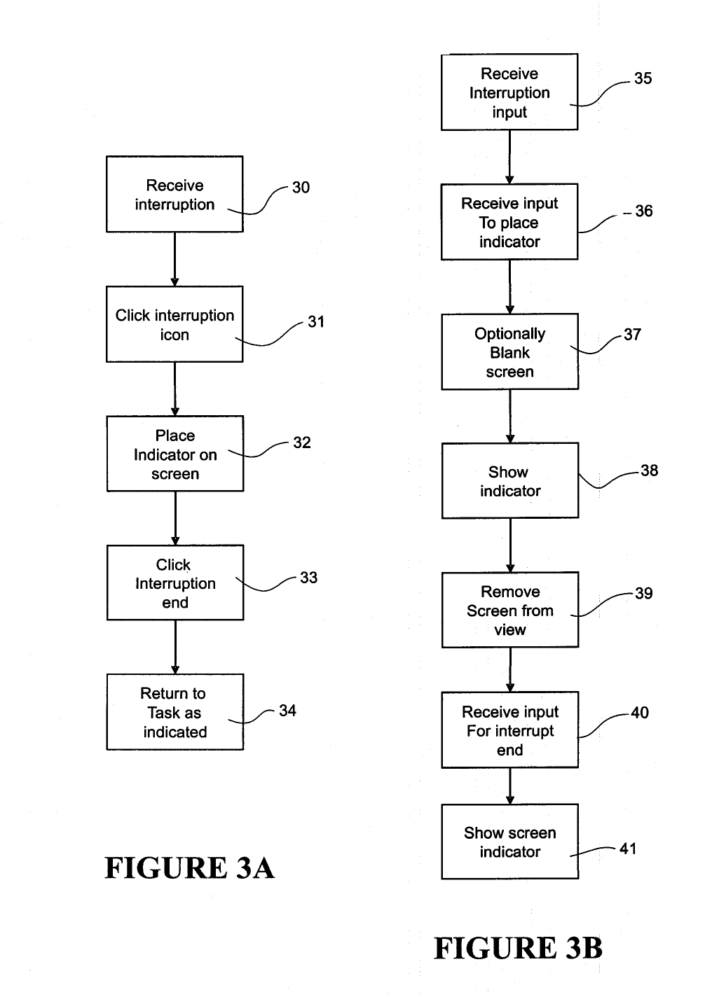

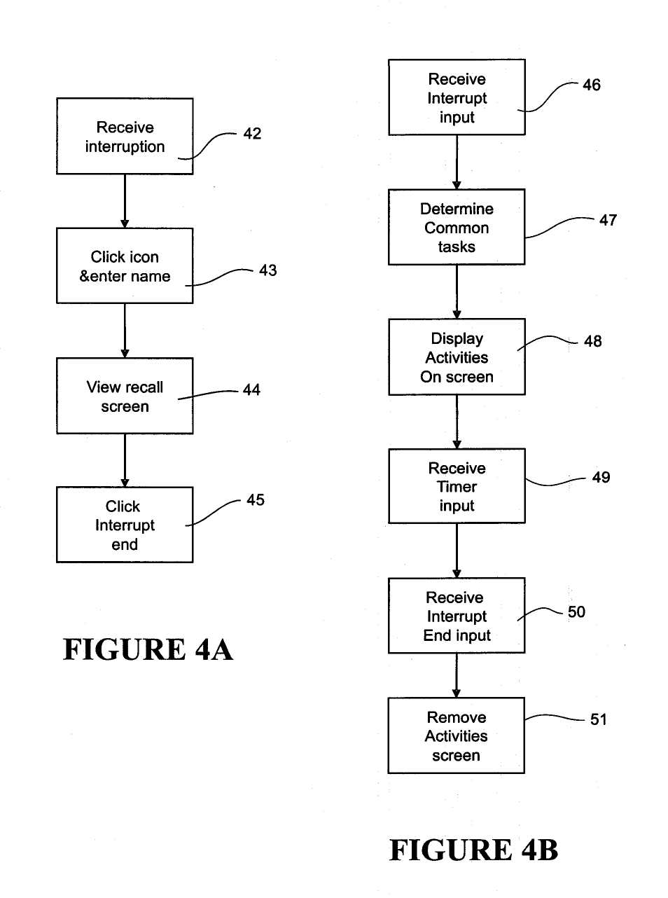

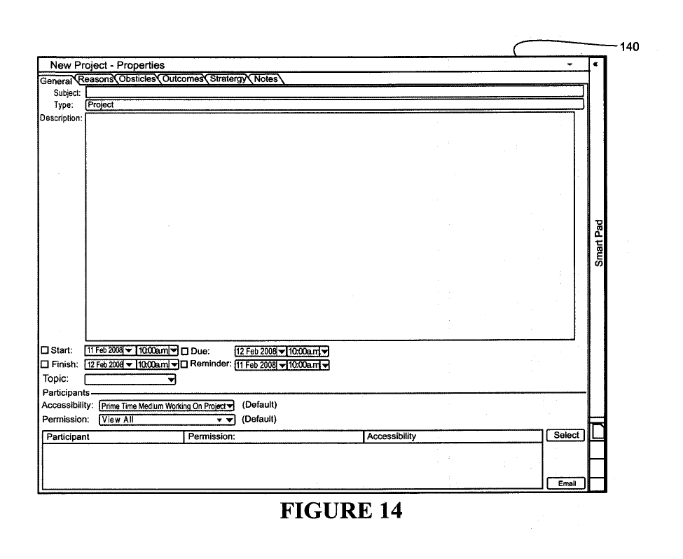

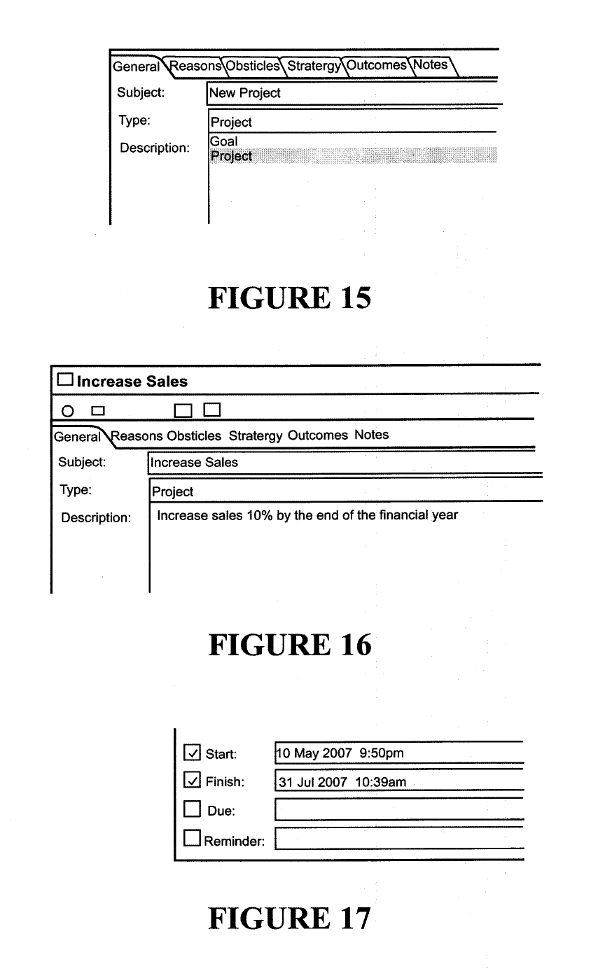

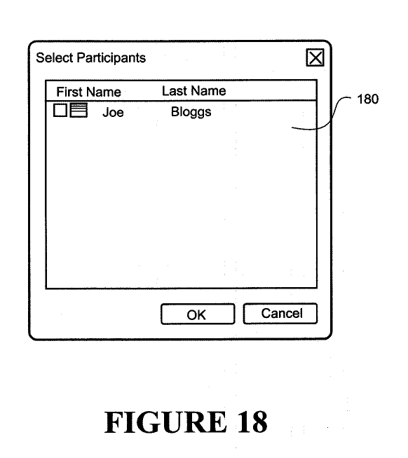

The operation of the invention, from both a user's (interruptee's) perspective and a computer system or software perspective shown in FIGS. 3a-4b. Prior to carrying out the method, the interruptee will have defined a number of activities (such as projects, goals, tasks and/or calendar items) on their computer applications. These can be defined as and when required on an adhoc basis, and will have been done as part of their usual planning process prior to becoming interruptee on any particular occasion. Some of these activities will have been associated with one or more people, being people that are related to or involved in the activities. The interrupter may also have defined such activities and associated people. This is described in relation to FIGS. 14 to 18. As shown in FIG. 14, to define a new activity, such as a project, the interruptee opens a screen 140, and selects to define a project (FIG. 15), and then enters details about the project (FIG. 16). Start and stop times can be entered for the project (FIG. 17), along with any other suitable information. The interruptee can also select one or more participants to the project, which will be associated people that are involved in the project in some manner. FIG. 18 shows a screen where a participant 180 (a person associated with the project) can be entered. Any other sort of activity (task, goal, calendar item or the like) can be entered in a similar manner using appropriate input screens. Other activities can also define associated people.

FIG. 3a shows a first embodiment of a method from an interruptee's perspective. Typically, a person about to be interrupted will be working on one or more applications displayed on their computer desktop (or more generally, their screen). When an interruptee receives an interruption from someone else, either by email, phone, instant message, physically or any other manner, step 30, they will indicate this on the computer by way of clicking an interruption icon or similar, step 31, shown on the desktop. They can then by way of their mouse, keyboard or other input means place an indicator (marker indicator) at the point on the screen that they are currently using, step 32. The indicator can take any suitable form. The computer will then show the marker indicator on the screen as positioned by the user, and afterwards remove from view the various applications that the user is currently working on, on the desktop from view. Prior to removing the applications from view, some or all of the desktop might be obscured totally or partially to protect privacy. Once the interruption has finished, the user can then indicate on the computer that the interruption has ended, step 33. The computer then returns all the applications the user was previously working on back to view, and also replaces a recall indicator in the position that the user marked prior to the interruption occurring, steps 33, 34. This assists the user to immediately see what they were doing prior to the interruption and enable them to get back to that task quickly.

FIG. 3b shows this method from a computer perspective. The computer first receives input from the user via some input device 11 that an interruption has occurred, step 35. They then receive input from the user, by way of keyboard, mouse or other input, step 36, indicating where to place the marker indicator on the screen. Note that these steps might be combined in a single operation. The computer then shows the indicator in that position, and optionally obscures the desktop, steps 37, 38. The computer then removes the various applications that the user was working on from view from the operating system desktop, step 39. After some time, the computer will receive input, by way of a mouse, keyboard or other means from the user that the interruption has ended step 40, and then return all the applications into view on the desktop and show an indicator or other graphical icon the original position marked by the user, steps 40, 41.

FIG. 4a shows another embodiment of the method from the interruptee's perspective. In this embodiment, the user receives an interruption from an interrupter via any normal means, such as physical interruption, call, instant message, email or the like, step 42. The interruptee then clicks an icon or makes another input to indicate that an interruption has occurred, step 43. A recall screen is then placed into view, which prompts for the interrupters name, step 49. The user enters this information and then the recall screen displays information indicating all the common activities (such as calendar items, tasks, projects, goals, scheduled meetings and the like) that the interruptee has previously defined, and has associated with the interrupter, step 44. This screen may also display all the activities that the interrupter has previously defined, and has as associated with the interruptee. The interruptee can then view this information and decide whether to accept the interruption and if so, what other discussions should take place between themselves and the interrupter based on their common tasks. Their interruptee may also click timing buttons or enter timing information to indicate how long they spent on discussing each of those activities. The user then indicates that the interruption has ended and the recall screen is removed from view, step 45.

This embodiment of the method will now be described from a computer system or software perspective with reference to FIG. 4b. The interruptee's computer receives input that an interruption has taken place in the usual manner, step 46. The computer then also receives information on who the interrupter is. The computer then looks at the various activities (such as tasks, projects, goals and calendar items) defined previously by the interruptee and looks at the personnel defined as being associated with those activities. If there are any items that are associated with the interrupter (meaning that the task is common to both the interruptee and interrupter) then the computer will determine that these should be displayed to the interruptee, step 47. If the interruptee's computer is networked with the interrupter's computer, the computer might also optionally look at the interrupter's defined activities such as tasks and calendar items, and determine which of those have been associated with the interruptee—namely which are common to both parties. The computer then displays a recall screen in which all the activities common to both the interrupter and interruptee (which may just be those found on the interruptee's computer, or those found in both the interrupter's and interruptee's computer) are displayed on the screen), step 48. The screen may also display icons or other entry points for indicating time spent on each of the tasks during the interruption. Optionally, the computer may receive input via a mouse click on an icon or text input that indicates time spent on each activity, step 49. Eventually, at the end of the interruption the system will receive input via a mouse, keyboard or other input device from the interruptee that the interruption has ended, step 50. The computer/software then removes the recall screen from view, step 51.

It will be appreciated that both the embodiments in FIGS. 3a to 4b might be combined, such that a interruptee can indicate an interrupt, mark their position on the screen, have the applications removed from view, receive recall information regarding common activities, and upon completion have their applications re-displayed with an indicator shown of their position prior to interruption. Similarly, from the computer system/software perspective, these two functionalities could be combined.

The methods described in FIGS. 3a, 4a will now be described in further detail with reference to screen shots of the interruptee's computer. The screen shots just show one preferred way of implementing the invention, and this should not be considered restrictive or the only manner in which the invention could be implemented. Any large number of implementations could be made as will be appreciated by those skilled in the art that carry out the general functionality described in FIGS. 3a-4b.

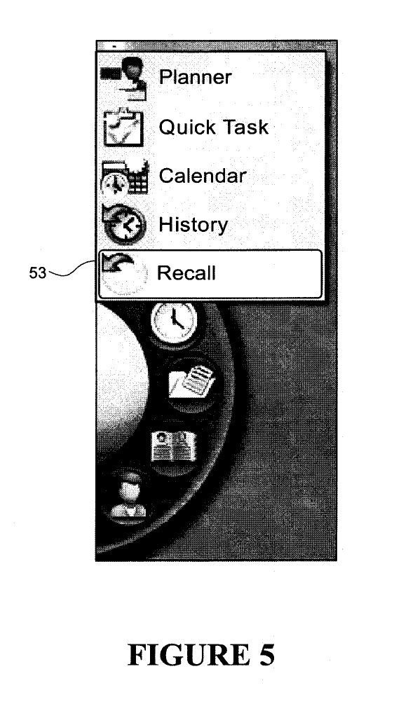

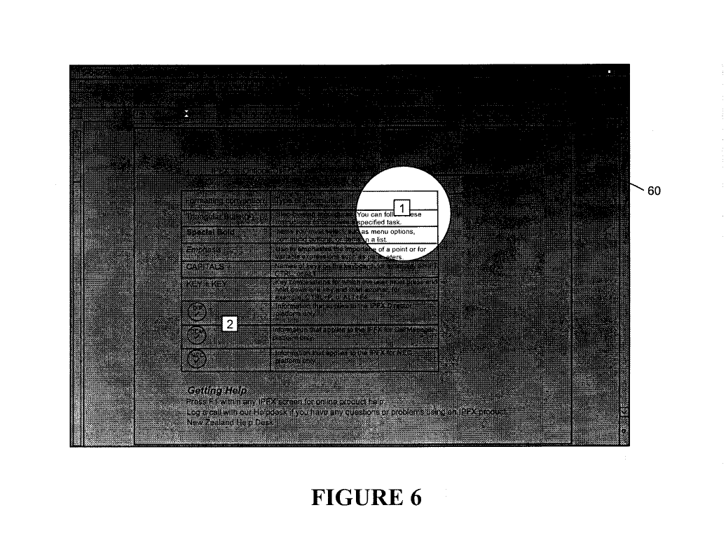

Referring to FIG. 5, when an interruptee receives an interruption they can click a recall icon 53 on a computer screen, or make some other alternative input means such as pressing a Windows hotkey. Referring to FIG. 6, once the icon is pressed, the computer then displays a marker indicator that can be placed anywhere on the desktop over any application or portion of application that is currently in use and shown on the desktop. At the time, the user will potentially be using a number of one or more applications, which will be displayed in windows or via other means on a computer desktop forming part of the computer's operating system.

The marker indicator can take any suitable form, such as an icon, marker, graphical device or the like. The marker might define a general region rather than being a point type marker as in the present case. For example, it could be a box, circle or the like. In this case, it takes the form of a clear window 60 that can be moved anywhere on the desktop. The marker indicator can then be placed in any suitable location on the desktop, in the general vicinity of the application and the particular portion in that application that the interruptee is currently working on. This helps the interruptee define their current location to help stabilise their memory in terms of the tasks they are currently working on, on the computer desktop.

In the present case shown in FIG. 6, the remainder of the desktop is obscured at least partially which provides privacy to prevent the interrupter seeing the bulk of the contents of the desktop. Securing the screen could take place by way of some kind of shading over or underneath the position of the marker, or in the present cases shown in FIG. 6 by surrounding the marker and providing a clear spot 60. It will be appreciated that obscuring the bulk of the screen in this manner is optional. In alternative embodiments, the marker indicator might be indicated, while the rest of the desktop still remains visible.

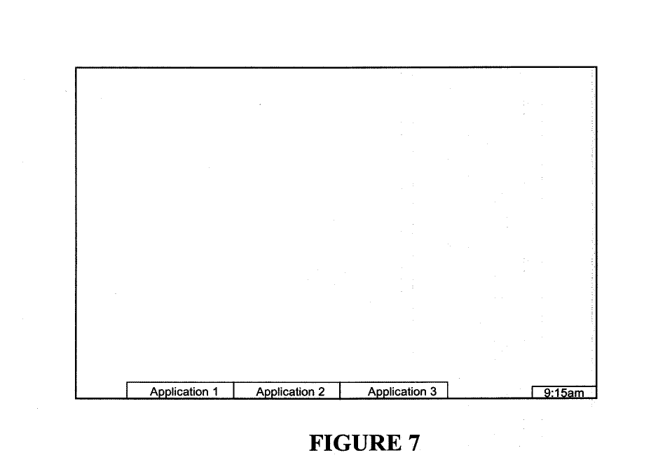

The user can then click a mouse button or make some other input to indicate that the position in which they have placed the marker indicator is the position on the desktop where they are currently working. Once this occurs, the application(s) currently being worked on are removed from the desktop, leaving a substantially clear desktop, as shown in FIG. 7. This enables the user to work on other applications while talking to the interrupter that may relate to their discussion topics.

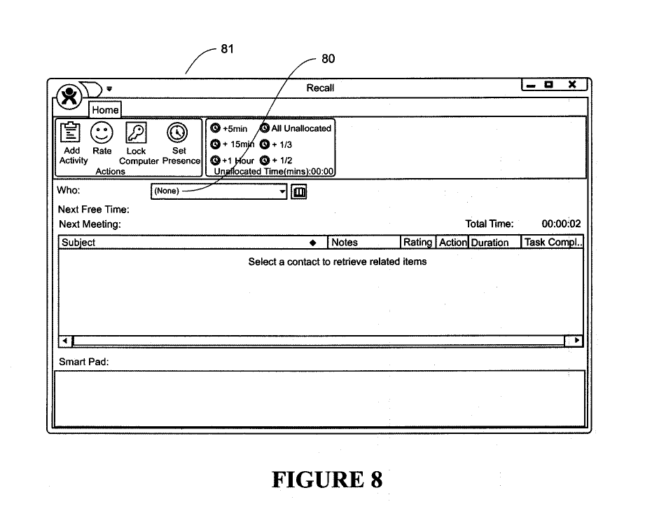

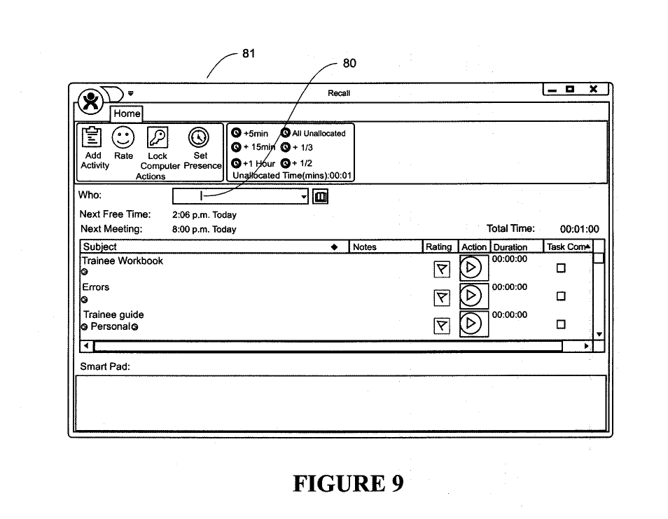

If the embodiment comprises providing a recall screen, then the following screens are shown with reference to FIGS. 8-12. The computer displays a recall screen 81, where they can enter the name of the interrupter in a field 80. This can be by way for example, of a drop down menu or text input. Name “Anna R” has been entered as the interrupter as shown in FIG. 9. This initiates a request for to the database 20 for all common data between the interruptee and the interrupter which is available. That is, after receiving this request from the interruptee's computer, the database server 20 scans all stored data for activities of the interruptee that have been associated with “Anna R”. The database 20 supplies back to the interruptee's computer a screen that will include or comprise all the activities (such as calendar items or tasks) that the interruptee has defined and has also associated with Anna R. In an alternative configuration, the interruptee's computer searches the activities on the local computer for any defined activities which the interruptee has defined and has also associated with “Anna R”. In addition, the database server 20, where the interrupter is networked to that server, can optionally scan the interrupters defined tasks, for any that have the interruptee associated. If so, these are also displayed on the recall screen 81.

FIG. 9 shows a sample of a recall screen in which some activities are shown that are common to the interruptee and the interrupter (Anna R). One item on the recall screen is the subject “trainee workbook”, which might be a task that the interrupter has previously defined as something they wish to discuss with the interruptee, and therefore have associated with them. The second item is errors, which is a task set up by the interruptee regarding the requirement to discuss errors with Anna R. The final item is a trainer's guide, which the interruptee has set up as a task being associated with Anna R. As can be seen, in this case all the items are tasks, although they could be calendar items or other activities. In this case the activities shown in the recall screen relate to activities both set up by Anna R (interrupter) and also the interruptee. In some instances only activities relating to one or the other might be shown. Once the recall screen is set up, the interruptee is able to view all mutual activities that require discussion, and this allows the user the ability to make an educated decision as to whether to:

1. accept the interruption, complete the interruption and close the information screen,

2. accept the interruption, complete the interruption, complete further tasks that involve the interrupter and close the interruption screen, or

3. try to negotiate the interruption to coincide with an existing meeting displayed on the information screen and close the information screen.

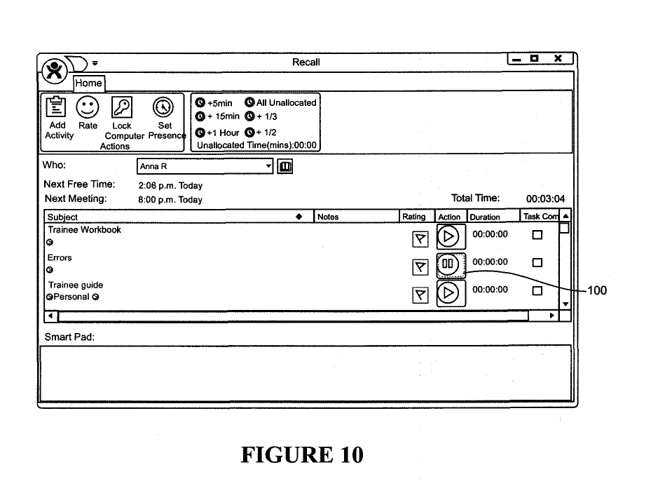

If the interruptee decides to proceed with the interruption they can then discuss various matters, including those actually mentioned in the recall screen. Referring to FIG. 10, in this case the interruptee has decided to discuss errors with the interrupter. In doing, so they can also click on the timer icon 100 to start timing on the task. This enables the time on the task to be recorded.

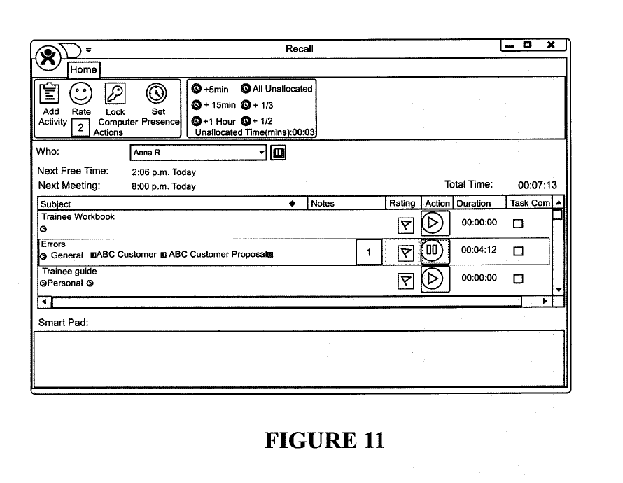

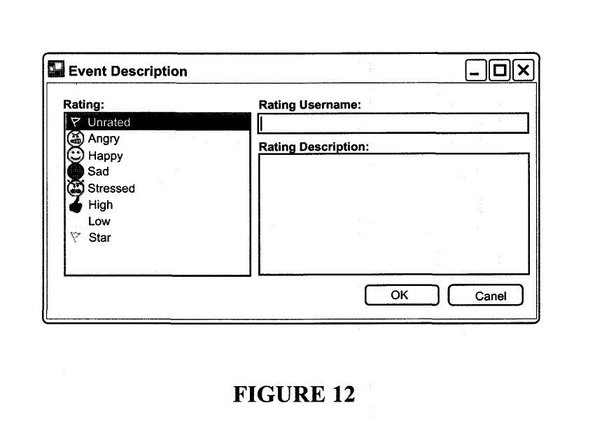

After a particular item on the recall screen has been discuss, the interruptee has the option of recording or rating the benefit of that discussion as shown in FIG. 11. They can click the rating icon, and then enter a rating description as shown in FIG. 12. This rating can be viewed later on to enable an interruptee to access the usefulness of the particular interruptions that they have had.

The interruptee can then go on to discuss other topics in the recall screen or unrelated topics. When the interruption has finally finished, the interruptee closes the recall screen.

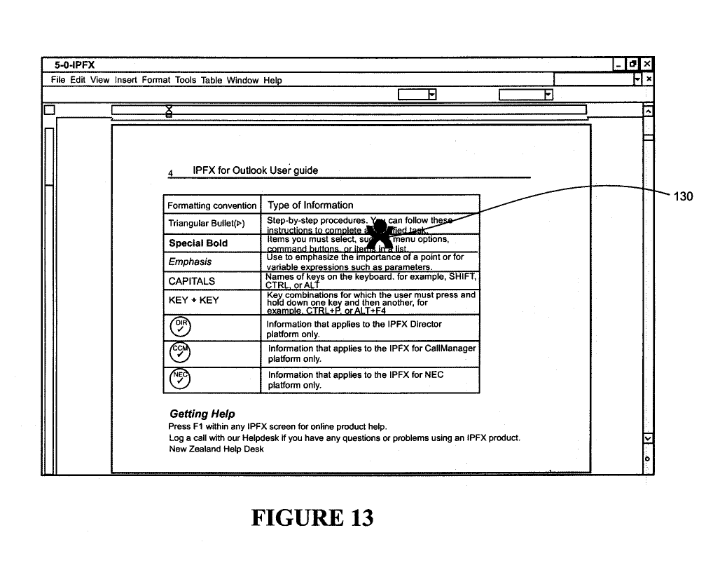

Referring to FIG. 13, once the user has indicated the end of the interruption the computer system re-displays all the applications that the user was working on prior to the interruption. The computer also displays a recall indicator 130 on the desktop in the same position as the original marker indicator was positioned by the interruptee prior to the interruption. This assists the user to go back directly to the particular portion of application or work that they were attending to prior to the interruption.

The positioning of the marker indicator immediately upon receiving the interruption, and the display of the recall indicator 130 after the interruption can take place anywhere on the screen and in relation to any application or other work being done on the desktop. Therefore, the marker can be superimposed on the desktop independently from the applications actually being used and executed. This means that the marker can be used even in applications where there is no particular cursor or text that can be marked by way of the application itself. Similarly, when the recall indicator 130 is shown after the interruption has ceased, this marker is superimposed over the desktop, independent of any cursors or markers actually produced by a particular applications. This again enables the user to go back to a particular spot on any type of application, whether it is text based or image based content.

Information from every interruption is stored in a database that the user can access either on an adhoc basis or during the recommended weekly review. The collated data will allow the user to see:

1. the number of interruptions,

2. length of interruptions,

3. the person interrupting,

4. if interruption is considered worthwhile,

5. how the user felt about the interruption, and

6. whether the interruptions are urgent enough to warrant being interruptions rather than parts of meeting agendas either individually or over a period of time.

In an alternative embodiment, the data that is shown in the recall screen is obtained from the interruptee's own computer, rather than being accessed from the database 20.

In an alternative embodiment, the database may only be local to each computer. There is no centralised database. In this case, only the discussion topics defined by the interruptee are obtained from the interruptee's local database and displayed.

In an alternative embodiment, the system might comprise one or more personal digital assistants (PDA) in addition to or in place of the computers. An interrupter or interruptee can utilise such a PDA in the same manner as describe for the computer, and the PDA contains software such that it operates to provide the method of the invention described above.

During an interruption on the recall screen showing information pertaining to the interrupter, time on a particular matter could be recorded via a timer button, or entered manually retrospectively.

1. A method for alleviating the effects of an interruption on a user using computer applications displayed on a screen, the method comprising the steps of:
receiving input for positioning a market indicator at a position on the screen and/or for indicating an interruption has occurred,
removing the marker indicator and one or more of the computer applications from view, and
upon receiving input indicating termination of the interruption, redisplaying the one or more computer applications and displaying a recall indicator on the screen in a position corresponding to the marker indicator.

2. A method according to claim 1 further comprising the step of reporting an interruption start time to a computer system.

3. A method according to claim 1 further comprising the step of reporting an interruption stop time to a computer system.

4. A method according to claim 1 further comprising prior to removing the computer applications from view, at least partially obscuring at least some portion of the screen.

5. A method according to claim 1 wherein the input for positioning the marker indicator is received from mouse or keyboard input.

6. A method for improving the efficiency of interruptions for an interruptee, the method comprising the steps of:
receiving input indicating an interruption,
receiving input identifying the interrupter,
displaying information pertaining to the interrupter.

7. A method according to claim 6 wherein the information pertaining to the interrupter comprises activities that have been defined by the interruptee and have been defined as being associated with the interrupter, the method further comprising the step of determining activities defined by the interruptee that are associated with the interrupter.

8. A method according to claim 6 or 7 wherein the information pertaining to the interrupter comprises activities that have been defined by the interrupter and have been defined as being associated with the interruptee, the method further comprising the step of determining activities defined by the interrupter that are associated with the interruptee.

9. A method according to claim 6 further comprising the step of reporting the interruption start time to a computer system.

10. A method according to claim 6, further comprising the step of reporting the interruption stop time to a computer system.

11. A method according to claim 6, further comprising the step of receiving input indicating the length of the interruption.

12. A method according to claim 6, further comprising the step of receiving input indicating the time at which the user is next available.

13. A method according to claim 6, further comprising the step of receiving input indicating the next scheduled meeting between the user and the interrupter

14. A method according to claim 6, further comprising the step of receiving input indicating discussion topics recorded by the user for the interrupter.

15. A method according to claim 6, further comprising the step of receiving input indicating discussion topics recorded by the interrupter for the user.

16. A method according to claim 6 wherein the information pertaining to the interrupter comprises information relating to activities common to the user and interrupter.

17. A method according to claim 13 wherein the information pertaining to the interrupter is obtained from activities specified for the interrupter.

18. A method according to claim 6 further comprising the step of receiving a rating for an interruption.
